(19) United States
(12) Patent Application Publication
(10) Pub. No.: US 2007/0295415 A1
(43) Pub. Date: Dec. 27, 2007

(54) Device for reducing hydraulic fluid oscillations in a hydraulic system

(76) Inventor: Klaus Boock, Timmdorf (DE)

Correspondence Address: JENKINS, WILSON, TAYLOR & HUNT, P. A., 3100 TOWER BLVD., Suite 1200, DURHAM, NC, 27707, US

(21) Appl. No.: 11/818,929

(22) Filed: Jun. 15, 2007

(30) Foreign Application Priority Data
Jun. 17, 2006 (DE) 10 2006 027 894.1

(51) Int. Cl. F16L 55/04

(52) U.S. Cl. 137/565.34

(57) ABSTRACT

Described is a device for reducing hydraulic fluid oscillations in a hydraulic system, in particular a hydraulic system of an aircraft, with the hydraulic system containing a hose line in which a fluid is conveyed under pressure pulsations, and with the hose line having an inner wall which delimits an inner cross section of the hose line. According to the invention, a line section is provided in the hose line, in which line section is arranged a tube of a predefined length, which tube has an outer cross section which is smaller than the inner cross section of the hose line, with a spacing to the inner wall of the hose line, with a first flow path being formed between the tube and the inner wall of the hose line and a second flow path being formed within the tube, such that mutual cancellation of the hydraulic fluid oscillations of the fluid flowing in the first flow path and the fluid flowing in the second flow path takes place.

### FIELD OF THE INVENTION

The invention relates to a device for reducing hydraulic fluid oscillations in a hydraulic system, in particular a hydraulic system of an aircraft, with the hydraulic system containing a hose line in which a fluid is conveyed under pressure pulsations, and with the hose line having an inner wall which delimits an inner cross section of the hose line.

### BACKGROUND ART

Hydraulic systems serve, in a wide range of applications, for conveying fluids which serve for very different purposes and can be conveyed under very different pressures. The fluids which are conveyed under pressure can exert mechanical work for control or drive purposes or can serve as fuels or oxidation means, can be lubricants or other substances, all fluids as are used in drive technology, process technology etc.

In aircraft, a plurality of usually independent hydraulic systems are typically provided, which generate the required pressure in the systems by means of pumps, such as in particular axial piston pumps. As an undesired by-product here, hydraulic fluid oscillations in the form of pressure pulsations are generated in the hydraulic lines, which can be perceived acoustically as unpleasant noise and can also, as additional loading of the lines, increase the possibility of leakages.

According to the prior art, pressure pulsations of said type can be reduced by means of reflection dampers or resonators which are connected to or joined into the hydraulic line.

### SUMMARY OF THE INVENTION

It is an object of the invention to create a device for reducing hydraulic fluid oscillations which is of effective and simple design and has a low spatial requirement.

This object is achieved by means of a device for reducing hydraulic fluid oscillations having the features of claim 1.

Advantageous embodiments and refinements of the device according to the invention are specified in the subclaims.

The invention creates a device for reducing hydraulic fluid oscillations in a hydraulic system, in particular a hydraulic system of an aircraft, with the hydraulic system containing a hose line in which a fluid is conveyed under pressure pulsations, and with the hose line having an inner wall which delimits an inner cross section of the hose line. According to the invention, a line section is provided in the hose line, in which line section is arranged a tube of a predefined length, which tube has an outer cross section which is smaller than the inner cross section of the hose line, with a spacing to the inner wall of the hose line, with a first flow path being formed between the rigid tube and the inner wall of the hose line and a second flow path being formed within the tube, such that mutual cancellation of the hydraulic fluid oscillations of the fluid flowing in the first flow path and the fluid flowing in the second flow path takes place.

The terms used here, hydraulic system or hydraulic line etc., are to be understood in their most general sense; they relate to any fluid which pertains to the principles of hydraulics, that is to say, in addition to so-called hydraulic oil, to fuels, lubricants, oxidation substances or all other fluids as are used in drive technology, process technology etc.

A significant advantage of the device according to the invention is that it is light and space-saving. A further advantage of the device according to the invention is that, in addition to hydraulic fluid oscillations or noise, mechanical loading of the hydraulic system caused by the pressure pulsations are also reduced.

It is provided according to one advantageous embodiment of the invention that the tube has a circular cross section.

According to one advantageous embodiment of the invention, the tube is arranged coaxially in the hose line.

The tube can be arranged in the hose line by means of spacers.

The tube can be produced from a rigid material.

The tube is preferably produced from a steel.

According to one embodiment of the invention, the first flow path between the tube and the inner wall of the hose line and the second flow path within the tube have substantially the same flow cross section.

According to another embodiment of the invention, the first flow path between the tube and the inner wall of the hose line and the second flow path within the tube have substantially the same flow resistance.

According to one embodiment of the invention, the tube is of such a length that there is a phase shift, by half a wavelength of a characteristic frequency of the hydraulic fluid oscillations, between the first flow path and the second flow path.

The tube is preferably of such a length that maximum cancellation of the hydraulic fluid oscillations in the first flow path and in the second flow path takes place.

An exemplary embodiment of the invention is explained below on the basis of the drawing, in which:

### BRIEF EXPLANATION OF THE DRAWINGS

FIG. 1 is a schematized, highly simplified illustration of a hydraulic system, for example a hydraulic system of an aircraft, in which a device for reducing hydraulic fluid oscillations, in particular for reducing hydraulic fluid noise, according to one exemplary embodiment of the invention can be used; and

FIG. 2 is a schematized, sectioned illustration of a device for reducing hydraulic fluid oscillations, in particular for reducing hydraulic fluid noise in a hydraulic system, according to one exemplary embodiment of the invention.

### DESCRIPTION OF PREFERRED EMBODIMENTS

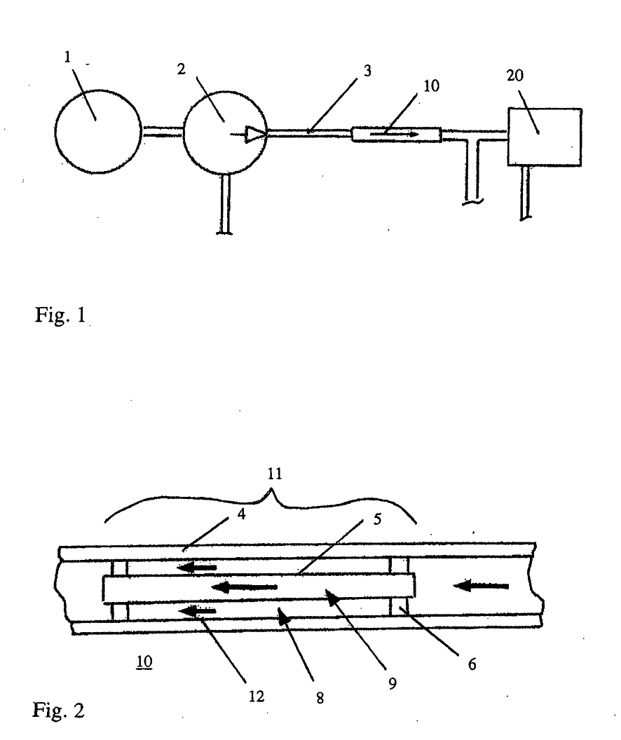

The device shown in FIGS. 1 and 2 serves for reducing hydraulic fluid oscillations, in particular for reducing hydraulic fluid noise in a hydraulic system such as a hydraulic system of an aircraft.

The hydraulic system contains a pump 2, typically an axial piston pump which operates at relatively low frequency, which is driven by a drive 1 in the form of a motor. Said pump 2 conveys a fluid 7 under pressure pulsations via a hydraulic line 3 to one (or more) connected machine components 20, where the fluid for example exerts work or is consumed, such as for example fuel to the engine of an aircraft. The hydraulic system contains a hose line 4 which is a constituent part of the hydraulic line 3 and through which the hydraulic fluid is conveyed under pressure pulsations by the pump 2.

Provided in the hydraulic line 3 is a device, denoted overall by the reference symbol 10, for reducing hydraulic fluid oscillations in the hydraulic system. Provided in the hose line 4, which has an inner wall 12 which delimits an inner cross section of the hose line 4, is a line section 11 in which is arranged a tube 5 of a predefined length l. The tube 5 has an outer cross section which is smaller than the inner cross section of the hose line 4, and is arranged with a spacing to the inner wall 12 of the hose line 4. Formed between the tube 5 and the inner wall of the hose line 4 is a first flow path 8, and a second flow path 9 is formed within the tube 5.

The wave which, in FIG. 2, runs in from the right propagates with a relatively low speed on account of the interaction with the flexible wall of the hose line 4. At the start of the tube 5, said wave splits into one wave part, which runs on relatively slowly on the first flow path 8 situated between the tube 5 and the inner wall of the hose line 4, and a second wave part which runs on at an increased speed on the second flow path 9 within the tube 5. Two waves of different phase position then converge at the end of the tube 5, which waves interfere with one another. With corresponding design of hose material, tube length, tube cross section, liquid and frequency of the pressure pulsations, the partial waves interfere destructively in the sense of mutual cancellation. The tube 5 can in particular be of such a length l that, for the hydraulic fluid oscillations propagating in the hydraulic line 3, there is a phase shift, by half a wavelength of a characteristic frequency of the hydraulic fluid oscillations, between the first flow path 8 and the second flow path 9. The length l is optimized such that maximum cancellation of the hydraulic fluid oscillations takes place.

The tube 5 has a circular cross section and is arranged coaxially in the hose line 4 by means of spacers 6. The tube 5 is produced from a material of high hardness, for example from steel.

The cross sections of the tube 5 and of the hose line 4 can be selected such that the first flow path 8 between the tube 5 and the inner wall of the hose line 4 and the second flow path 9 within the tube 5 have substantially the same flow cross section.

Alternatively, for example, the cross sections of the tube 5 and of the hose line 4 can be selected such that the first flow path 8 between the rigid tube 5 and the inner wall of the hose line 4 and the second flow path 9 within the rigid tube 5 have substantially the same flow resistance.

What is claimed is:

1. A device for reducing hydraulic fluid oscillations in a hydraulic system, the hydraulic system containing a hose line in which a fluid is conveyed under pressure pulsations, and the hose line having an inner wall which delimits an inner cross section of the hose line, the hose line comprising a line section,
wherein a tube of a predefined length is arranged in the line section,
the tube having an outer cross section which is smaller than the inner cross section of the hose line,
the tube being arranged at a spacing to the inner wall of the hose line,
a first flow path being formed between the tube and the inner wall of the hose line, and
a second flow path being formed within the tube, such that mutual cancellation of the hydraulic fluid oscillations of the fluid flowing in the first flow path and the fluid flowing in the second flow path takes place.

2. The device according to claim 1, wherein the tube has a circular cross section.

3. The device according to claim 1, wherein the tube is arranged coaxially in the hose line.

4. The device according to claim 1, wherein the tube is arranged in the hose line by means of spacers.

5. The device according to claim 1, wherein the tube is produced from a rigid material.

6. The device according to claim 5, wherein the tube is produced from a steel.

7. The device according to claim 1, wherein the first flow path between the tube and the inner wall of the hose line and the second flow path within the rigid tube have substantially the same flow cross section.

8. The device according to claim 1, wherein the first flow path between the tube and the inner wall of the hose line and the second flow path within the tube have substantially the same flow resistance.

9. The device according to claim 1, wherein the tube is of such a length that there is a phase shift, by half a wavelength of a characteristic frequency of the hydraulic fluid oscillations, between the first flow path and the second flow path.

10. The device according to claim 1, wherein the tube is of such a length that maximum cancellation of the hydraulic fluid oscillations in the first flow path and in the second flow path takes place.

11. The device according to claim 1, wherein the hydraulic system is a hydraulic system of an aircraft.
